(19) United States
(12) Patent Application Publication
(10) Pub. No.: US 2003/0124977 A1
(43) Pub. Date: Jul. 3, 2003

(54) Self-positioning wireless transceiver system and method

(76) Inventors: Dwight Randall Smith, Grapevine, TX (US); Steven Jeffrey Goldberg, Downington, PA (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/034,082

(22) Filed: Dec. 28, 2001

(51) Int. Cl. H04Q 7/20

(52) U.S. Cl. 455/16; 455/41; 455/445; 455/414

(57) ABSTRACT

A self-positioning wireless transceiver system increases the communication range of a source device. A plurality of communicatively coupled self-positioning transceivers automatically position themselves with respect to the source device to increase the communication range of the source device. When communicative coupling between the source device and a particular destination device within the increased communication range is detected, the plurality of self-positioning transceivers automatically position themselves and create a communication link between the source device and the destination device. Each of the self-positioning transceivers includes a mobility mechanism that permits the self-positioning transceiver to automatically position itself as necessary to create desired communication links.

### FIELD OF THE INVENTION

The present invention relates generally to a method and apparatus for a transceiver system and more particularly, to a method and apparatus for extending the communication range of a source device using a self-positioning wireless transceiver system.

### BACKGROUND OF THE INVENTION

The capabilities, features and functions of wireless communication devices have experienced tremendous growth in recent years. Devices such as cellular telephones, personal computers, laptops, pagers, personal digital assistants (PDAs) are routinely used to send and/or receive one or more different types of communication data such as for example, voice messages, text messages, image files, video files, and audio files. An increasing amount of communication data is exchanged via wireless communication paths.

Advances in wireless communication technologies are permitting people to maintain increased levels of communication contact independent of their locations. Prior art communication technologies generally provide wireless communication links between communication devices via fixed communication network equipment. Fixed communication networks generally provide communication coverage of a defined area. For example, fixed communication networks for cellular communication devices typically include a plurality of base transceiver stations (BTSs) that provide communication coverage of a specific geographic area. The areas covered by such a communication network are typically divided into a number of smaller communication sites (cells) where each communication site is served by at least one BTS. When a communication device, such as a cellular telephone, is within communication range of a particular BTS within the fixed communication network, a communication link can be established with a second communication device within the geographic area covered by the fixed communication network. However, if one or both of the communication devices move out of range of the fixed communication network, a communication link typically cannot be established or maintained between the two communication devices.

Furthermore, a particular BTS within the fixed communication network may experience traffic overload conditions caused by an excessive number of communication devices within a cell associated with the BTS attempting to create or maintain communication links. Such traffic overload conditions may be temporary conditions that occur within a cell during events that attract large crowds of people, such as for example crowds in a stadium during a football game. While prior art transceivers may be manually positioned strategically to divert excessive traffic to alternate BTSs, the placement and removal of such transceivers often require time and labor.

In addition, increased numbers of devices, such as laptops, often require temporary communication links to a local area network to permit the sharing of resources, such as for example shared databases or shared printing resources, during a business meeting or a conference. Typically the laptops are required to be within close proximity of a communication port to the established local area network or of a prior art transceiver that is specifically placed to create necessary communication links to the fixed local area network. Such prior art transceivers are often positioned manually to support necessary communication links. The use of such fixed communication networks and/or strategically placed transceivers often require advance planning, time and labor.

Also, at times, communication obstacles may interfere with the ability of a communication device to establish a wireless communication link with a desired communication device. While fixed communication network devices may be used to overcome obstacles in areas where communication links are frequently established, lower communication traffic areas may not have requisite network elements to overcome the communication obstacle.

Thus there is a need for an apparatus and a method for creating a spontaneous temporary self-adjusting wireless communication network that is adapted to establish and/or maintain communication links between one or more communication devices.

### BRIEF DESCRIPTION OF THE DRAWINGS

FIG. 1 is a block diagram representation of a self-positioning wireless transceiver system in accordance with an embodiment of the present invention.

FIG. 2 is a block diagram representation of a control unit of a self-positioning transceiver of FIG. 1.

FIG. 3 is a block diagram representation of an example of a configuration of self-positioning transceivers positioned to overcome a communication obstruction in accordance with the principles of the present invention.

FIG. 4 is a block diagram representation of an example of a configuration of self-positioning transceivers deployed in a “swarm” to create multiple communication paths between the source device and the destination device in accordance with the principles of the present invention.

FIG. 5 is a block diagram representation of an example of a reconfiguration of the self-positioning transceivers of FIG. 4 as the communication distance between the source device and the destination device is increased in accordance with the principles of the present invention.

FIG. 6 is a block diagram representation of an example of a configuration of the self-positioning transceiver system to create an ad hoc network in accordance with the principles of the present invention.

FIG. 7 is a block diagram representation of an example of a configuration of the self-positioning transceiver system to create a wide area network in accordance with the principles of the present invention.

FIG. 8 is a block diagram representation of an example of a scanning configuration of the self-positioning transceiver system in accordance with the principles of the present invention.

FIG. 9 is a flowchart illustrating a method of establishing a generally spherical scanning configuration in accordance with the principles of the present invention.

FIG. 10 is a flowchart illustrating a method of creating a communication link between a source device and a destination device via the self-positioning wireless transceiver system in accordance with the principles of the present invention.

FIG. 11 is a block diagram representation of examples of positions of self-positioning transceivers following the execution of various steps of the method of FIG. 10.

FIG. 12 is a flowchart illustrating a method of maintaining a quality communication link between the source device and the destination device as the source device moves away relative to the destination device in accordance with the principles of the present invention.

FIG. 13 is a block diagram representation of examples of positions of self-positioning transceivers following the execution of various steps of the method of FIG. 12.

FIG. 14 is a flowchart illustrating a method of accommodating the movement of a source device towards a destination device in accordance with the principles of the present invention.

FIG. 15 is a block diagram representation of examples of relative positions of self-positioning transceivers, a source device and a destination device at various steps of the method of FIG. 14.

FIG. 16 is a block diagram representation of a crossover configuration and of a shorter communication link created in response to the detection of the crossover configuration in accordance with the principles of the present invention.

FIG. 17 is a flowchart illustrating a method of retrieving deployed self-positioning transceivers in accordance with the principles of the present invention.

FIG. 18 is a flowchart illustrating an alternate method of retrieving deployed self-positioning transceivers in accordance with the principles of the present invention.

FIG. 19 is a block diagram representation of examples of relative positions of self-positioning transceivers, a source device and a destination device at various steps of the method of FIG. 18.

### DETAILED DESCRIPTION OF THE PREFERRED EMBODIMENTS

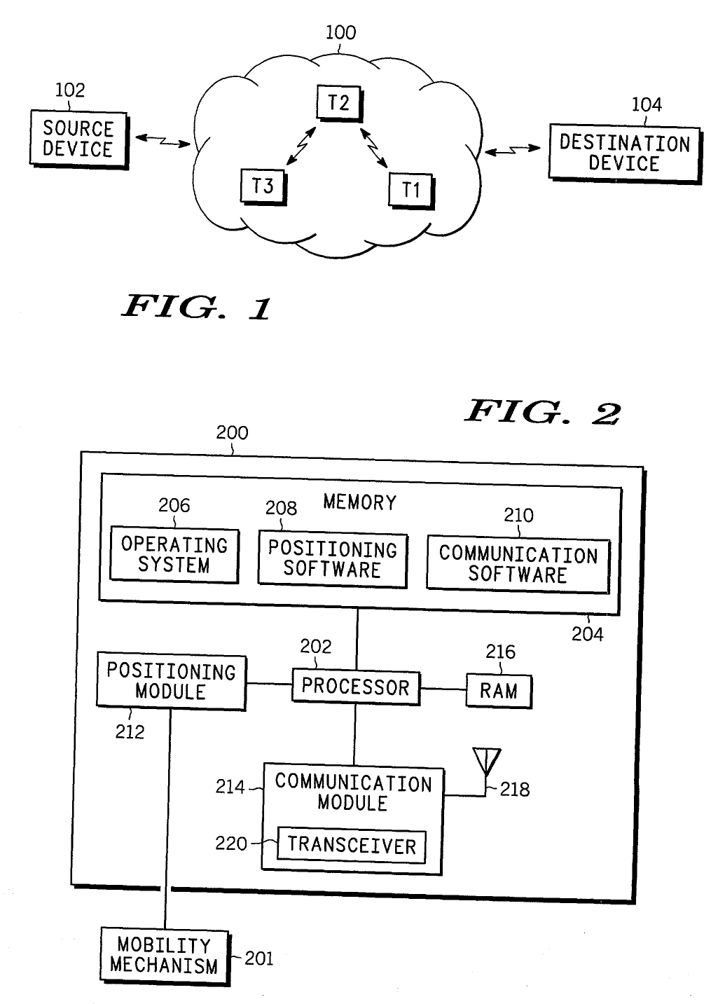

Referring to FIG. 1, a self-positioning wireless transceiver system 100 establishes a wireless communication path between a source device 102 and one or more destination devices 104 in accordance with an embodiment of the invention. The self-positioning wireless transceiver system 100 generally includes a plurality of communicatively coupled self-positioning transceivers T1, T2, T3 with the lead self-positioning transceiver T1 being directly communicatively coupled to the destination device 104. One or more communication links are created between the source device 102 and the destination device 104 via one or more of the communicatively coupled self-positioning transceivers T1, T2, T3.

A dedicated control channel is used to transmit self-positioning transceiver specific operational data, while a payload channel is used to transmit communication data packets generated by the source device 102 and/or the destination device 104. Each self-positioning transceiver T1, T2, T3 receives communication data packets from a source device 102, a destination device 104 or neighboring self-positioning transceivers T1, T2, T3 depending on the direction of the communication path and the position of the self-positioning transceiver T1, T2, T3 within the communication link. The self-positioning transceiver T1, T2, T3 then transmits the received communication data packet to the source device 102, the destination device 104 or a neighboring self-positioning transceiver T1, T2, T3, again based on the direction of the communication path and the position of the self-positioning transceiver T1, T2, T3 within the communication link. For example, in FIG. 1, the source device 102 may initiate the transmission of a communication data packet. The first self-positioning transceiver T3 receives the communication data packet and retransmits the data packet on a dedicated payload communication channel to the next self-positioning transceiver T2. The communication packet is received and retransmitted in this manner down the communication link until the communication data packet reaches the lead self-positioning transceiver T1, which in turn communicates the communication data packet to the destination device 104.

The types of communication data exchanged between the source device 102 and the destination device 104 via the self-positioning wireless transceiver system 100 may be, but is not limited to, voice messages, text messages, image files, video files and audio files. Examples of source devices 102 and/or destination devices 104 may, for example, comprise cellular telephones, personal computers, laptops, pagers, personal digital assistants (PDAs), base transceiver stations (BTS), or any other type of device including functions for receiving and/or transmitting wireless communication data.

The self-positioning wireless transceiver system 100 may be compatible with source devices 102 and destination devices 104 operating in accordance with at least one of several communication standards. These standards include analog, digital or dual mode communication system protocols such as, but not limited to, the Advanced Mobile Phone System (AMPS), the Narrowband Advanced Mobile Phone System (NAMPS), the Global Positioning System for Mobile Communication (GSM), the IS-55 Time Division Multiple Access (TDMA) digital cellular, the IS-95 Code Division Multiple Access (CDMA) digital cellular, CDMA 2000, the Personal Communication System (PCS), 3G, Frequency Division Multiple Access (FDMA) protocols and variations and evolutions of these protocols.

The self-positioning transceivers T1, T2, T3 may be adapted to operate in accordance with one of several short-range communication specifications. These short-range communication specifications include but are not limited to, Bluetooth specifications, the IEEE 802.11 family of specifications, and variations and evolutions of these communication protocols and specifications.

Bluetooth is a computing and telecommunications industry specification that generally defines the manner in which two or more devices communicate with each other using short-range wireless connections. An embodiment of the self-positioning wireless transceiver system 10, adapted to operate in accordance with Bluetooth specifications generally includes self-positioning transceivers T1, T2, T3 that are typically equipped with a microchip transceiver that transmits and receives communication data in a previously unused frequency band of 2.45 gigahertz. Of course, the frequency band may vary depending on local regulations for individual countries. Each self-positioning transceiver T1, T2, T3 used, is typically assigned a unique address such as for example, a 48-bit address in accordance with the IEEE 802.11 standard. Communication links created between neighboring self-positioning transceivers T1, T2, T3, a self-positioning transceiver T3 and the source device 102 and/or a self-positioning transceiver T1 and the destination device 104 may, in accordance with Bluetooth technology, comprise point-to-point or multipoint communication links. The wireless communication range for the self-positioning transceivers T1, T2, T3 is typically approximately ten meters, however, the use of alternative wireless communication ranges are also considered to be within the scope of the invention. Communication data packets may be exchanged between neighboring communication devices, such as the source device 102, neighboring self-positioning transceivers T1, T2, T3 and/or the destination device 104 at a communication data transmission rates of approximately one megabit per second or as high as approximately two megabits per second, when using second generation technologies. Frequency hop schemes may be employed to permit the self-positioning transceivers T1, T2, T3 to communicate with each other in areas with relatively high levels of electromagnetic interference. Built-in encryption and verification protocols, as are well known to one skilled in the art, may also be incorporated.

The IEEE 802.11 is a family of specifications currently including four specifications, 802.11, 802.11a, 802.11b and 802.11g. An embodiment of the self-positioning wireless transceiver system 10, adapted to operate in accordance with the IEEE 802.11 family, typically employs Ethernet protocol and carrier sense multiple access with collision avoidance (CSMA/CA) path sharing applications. The self-positioning wireless transceiver system 10 generally includes self-positioning transceivers T1, T2, T3 that are typically equipped with a microchip transceiver that transmits and receives communication data in a previously unused frequency band of 2.45 gigahertz. Of course, the frequency band may vary depending on local regulations for individual countries. An embodiment of the self-positioning wireless transceiver system 10, adapted to operate in accordance with the 802.11a specifications generally operates at radio frequencies ranging from approximately five gigahertz to approximately six gigahertz. Under the 802.11a standard, the use of an orthogonal frequency-division multiplexing (OFDM) modulation scheme enables the exchange of communication data packets between neighboring self-positioning transceivers T1, T2, T3, between a self-positioning transceiver and the source device 102 or the destination device 104 at communication data transmission rates, such as but not limited to, approximately six megabits per second, approximately twelve megabits per second, approximately twenty-four megabits per second or even at communication data transmission rates as high as approximately fifty-four megabits per second.

An embodiment of the self-positioning wireless transceiver system 10, adapted to operate in accordance with the 802.11b standard, employs a complementary code keying (CCK) modulation scheme. The use of the CCK modulation scheme typically supports relatively high communication data transmission rates between with reduced susceptibility to multipath-propogation interference.

An embodiment of the self-positioning wireless transceiver system 10, adapted to operate in accordance with the 802.11g standard, permits communication data transmissions over relatively short distances at communication data transmission rates of up to approximately 54 megabits per second. Alternate embodiments of the self-positioning wireless transceiver system 100 may operate in accordance with infrared and/or ultrasonic communication standards and protocols as are known to one skilled in the art.

Referring to FIG. 2, each self-positioning transceiver T generally includes a mobility mechanism 201 that permits the self-positioning transceiver T to adjust its own position as necessary to create and/or maintain a particular communication link. Examples of mobility mechanisms include, but are not limited to, radio-controlled land-craft, aircraft, and watercraft. Alternative types of mobility mechanisms 201, such as those that hover, swim, crawl or reposition themselves using other forms of attitude control and mobility, are considered to be within the scope of the invention. Of course mobility mechanisms, such as those that are responsive to signals transmitted and received via infrared or ultrasonic frequency channels are also considered to be within the scope of the invention.

The mobility mechanism 201 is generally equipped with a control unit 200. The control unit 200 includes a processor 202, a memory 204 including an operating system 206, positioning software 208, communications software 210, a positioning module 212, a communication module 214, a random access memory (RAM) 216 and an antenna 218.

The positioning module 212 is communicatively coupled to the processor 202 and to the mobility mechanism 201. During operation, the processor 202 employs the positioning software 208 to identify adjustments to the positions of the self-positioning transceivers T1, T2, T3 relative to neighboring self-positioning transceivers T1, T2, T3, the source device 102 and/or the destination device 104 based on signals received from such devices via the positioning module 212 in an attempt to optimize the quality of communication links between such devices. Based on identified adjustments, the processor 202 issues commands to the mobility mechanism 201 to adjust the position of the self-positioning transceiver T1, T2, T3.

The communications module 214 typically includes a transceiver 220 and is communicatively coupled to the processor 202 and the antenna 218. The processor 202 employs the communication software 210 to processes communication data signals received and transmitted via the antenna 218.

The RAM 216 is communicatively coupled to the processor 202 and is generally used to maintain self-positioning transceiver specific operational data including one or more of, but not limited to, the number of neighboring self-positioning transceivers T1, T2, T3, destination devices 104 within communication range of the wireless self-positioning transceiver system 100, communication link quality parameters relating to the quality of individual communication links with neighboring self-positioning transceivers T1, T2, T3, the number of self-positioning transceivers T1, T2, T3 necessary to communicatively link the source device 102 to different destination devices 104, aggregate communication link quality between the source device 102 and the destination device 104, parameters relating to the location of the self-positioning transceiver T1, T2, T3 relative to the source device 102 and directional data with reference to neighboring self-positioning transceivers T1, T2, T3.

The self-positioning wireless transceiver system 100 may be deployed using any one of a number of different methods. The self-positioning transceivers T may all be deployed at once by a user or automatically by a system as required to create and/or maintain desired communication links between source devices 102 and destination devices 104. The manner in which the self-positioning transceivers are deployed may vary for the different embodiments of the invention.

In one embodiment, the self-positioning wireless transceiver system 100 is deployed by a user and specifically instructed to strengthen or establish a communication link between a source device 102 and a destination device 104 while the source device 102 is still within communication range to receive signals, including relatively weak signals, from the destination device 104. For example, the self-positioning wireless transceiver system 100 is instructed to maintain a communication link between a source device 102, such as a cellular telephone, and a destination device 104, such as a BTS within a cellular network, as the cellular telephone is moving out of communication range of the cellular network. In such cases, the self-positioning wireless transceiver system 100 is typically deployed while the source device 102 is still within communication range of the destination device 104.

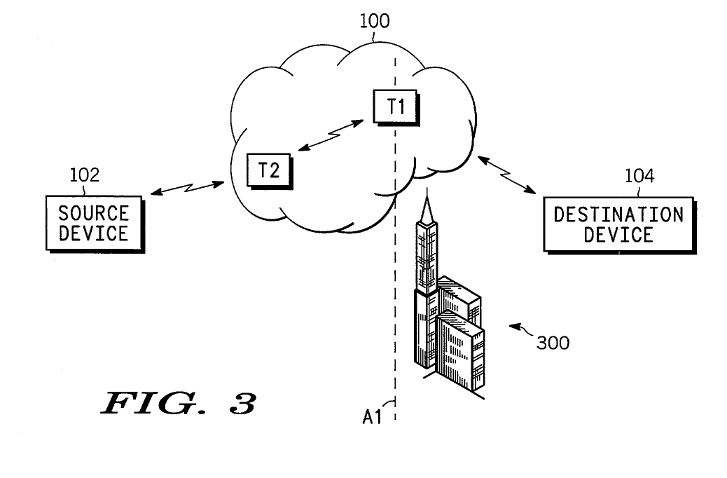

In an alternative embodiment, the self-positioning wireless transceiver system 100 is deployed with instructions to search for a communication signal from a specific destination device 104 using a predefined search pattern. For example, referring to FIG. 3, an obstruction 300 prevents the exchange of communication signals between the source device 102 and the destination device 104. The self-positioning transceivers T1, T2 are deployed and instructed to search for a communication signal from the destination device 104 using a predefined search pattern. More specifically, in the illustrated example, one of the self-positioning transceivers T2 assumes a position within communication range of the source device 102 as a second self-positioning transceiver T1 moves along a generally vertical axis A1 searching for a communication signal from the destination device 104 while maintaining a communication link with self-positioning transceiver T2.

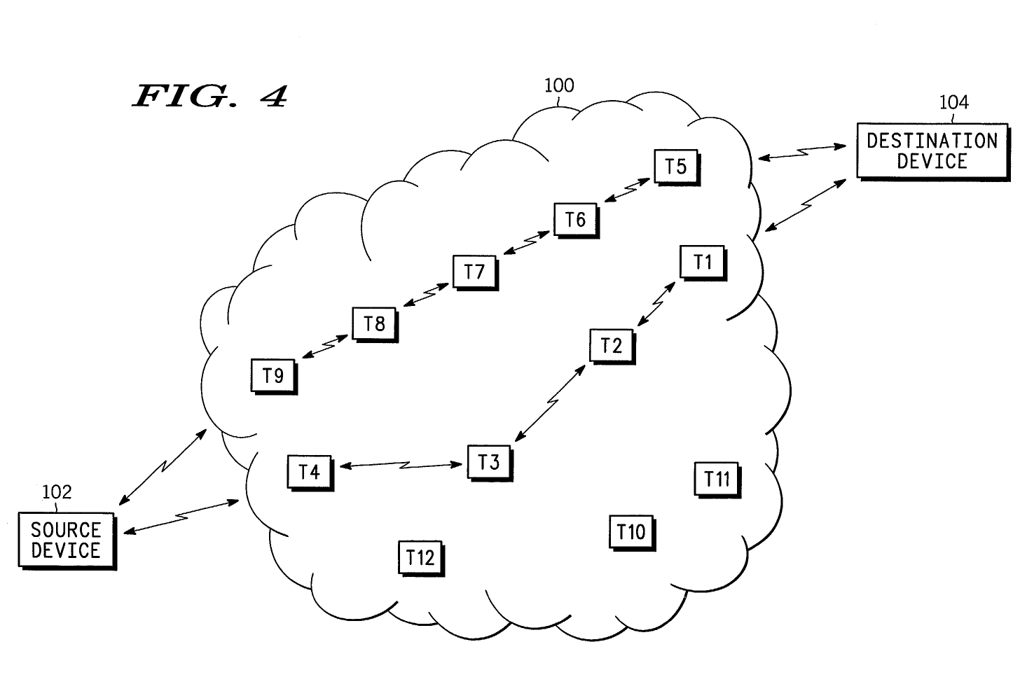

Referring to FIG. 4, an alternative embodiment is shown, where the self-positioning wireless transceiver system 100 is deployed in a “swarm” with the deployment of a significantly greater number of self-positioning transceivers T1-T12 than necessary to support a single communication link between the source device 102 and the destination device 104. A subset of the deployed self-positioning transceivers T4, T3, T2, T1 establish a primary communication link between the source device 102 and the destination device 104. A subset of the remaining self-positioning transceivers T9, T8, T7, T6, T5 create one or more alternate communication paths between the source device 102 and the destination device 104. In the event that the primary communication path is disrupted as a result of, for example a self-positioning transceiver malfunction or a self-positioning transceiver loss, a communication link can immediately be reestablished between the source device 102 and the destination device 104 via one of the alternate communication paths.

Furthermore, if one or both of the source device 102 and destination device 104 are moving slowing with respect to each other, each of self-positioning transceivers T4, T3, T2, T1 within the “swarm” automatically repositions itself with respect to neighboring self-positioning transceivers T1-T4 to maintain the established primary communication link and if necessary create alternate communication paths. As the source device 102 and the destination device 104 move with respect to each other, the self-positioning transceivers T1-T9 automatically reposition themselves with respect to each other to maintain a fairly uniform distribution of self-positioning transceivers T1-T9 based on the quality of individual communication links between neighboring self-positioning transceivers T1-T9. Maintaining uniformity in individual communication links generally promotes greater aggregate communication link quality between the source device 102 and the destination device 104.

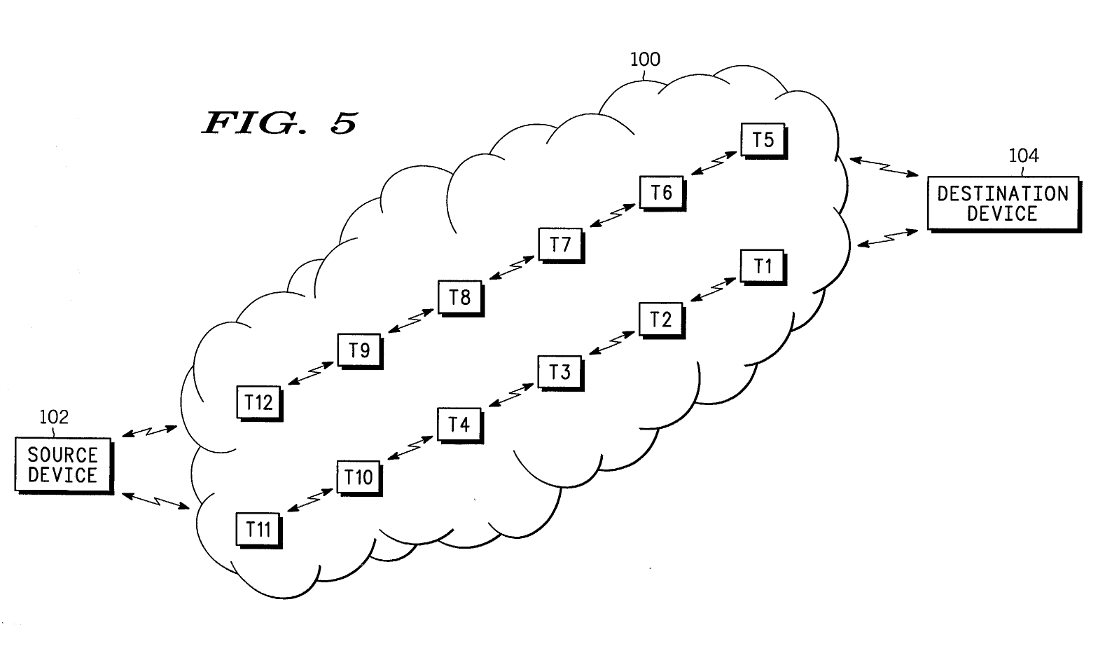

Referring to FIG. 5, in an alternative scenario, if for example, the source device 102 and the destination device 104 move a sufficient distant apart, additional self-positioning transceivers T10, T11 may be required to lengthen the string of communicatively coupled self-positioning transceivers T11, T10, T4, T3, T2, T1 necessary to extend the primary communication link from the source device 102 to the destination device 104. The increased distance between the source device 102 and the destination device 104 may also require the use of a greater number of self-positioning transceivers T12 to create alternate communication paths thereby requiring the automatic reconfiguration of the remaining self-positioning transceivers T12, T9, T8, T7, T6, T5 to create one or more communication paths between the source device 102 and the destination device 104. However, since fewer self-positioning transceivers T may be available to create alternative communication paths, it is possible that the reconfigured “swarm” may have a fewer number of alternative communication paths when compared to a previous self-positioning transceiver configuration.

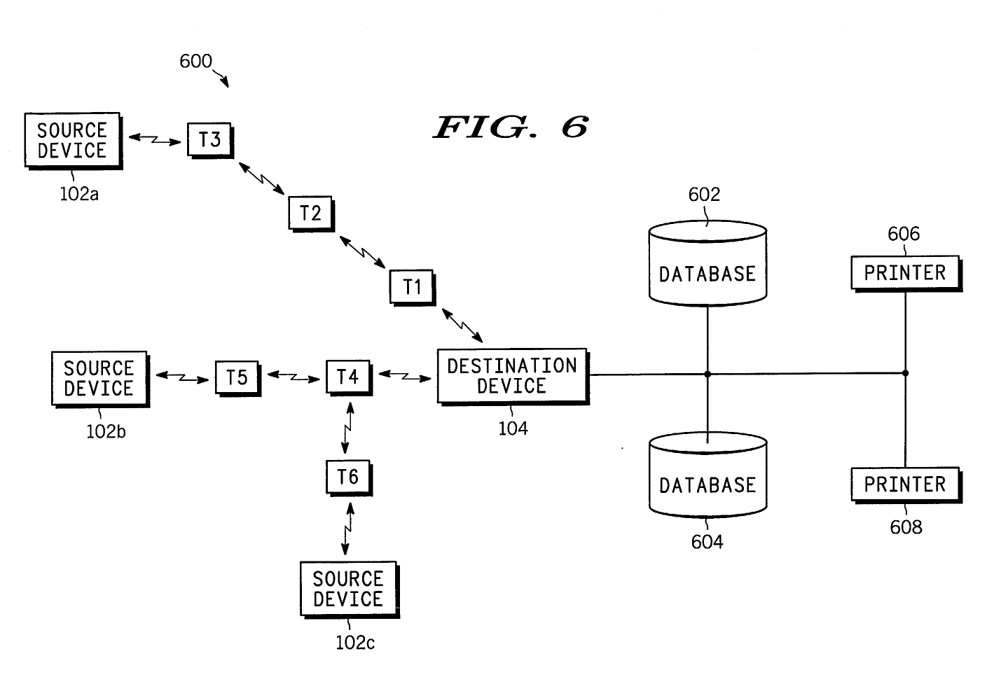

In another embodiment, as shown in FIG. 6, the self-positioning transceivers T1-T6 can be deployed, as needed, to create specific types of temporary networks. The self-positioning transceivers T1-T6 can automatically position themselves, for example, to create an ad-hoc or a “spontaneous” local area network 600 communicatively coupling one or more source devices 102a, 102b, 102c, such as for example, a plurality of laptops, to a local network with shared databases 602, 604 and printing resources 606, 608 via a destination device 104, such as a communication port, for the duration of a conference session. The self-positioning transceivers T1, T2, T3 may be instructed to position themselves to create an individual pathway between the source device 102a and one or more destination devices 104. In an alternative embodiment, the self-positioning transceivers T4, T5, T6 may be instructed to create shared pathways communicatively coupling source devices 102b, 102cto one or more destination devices 104.

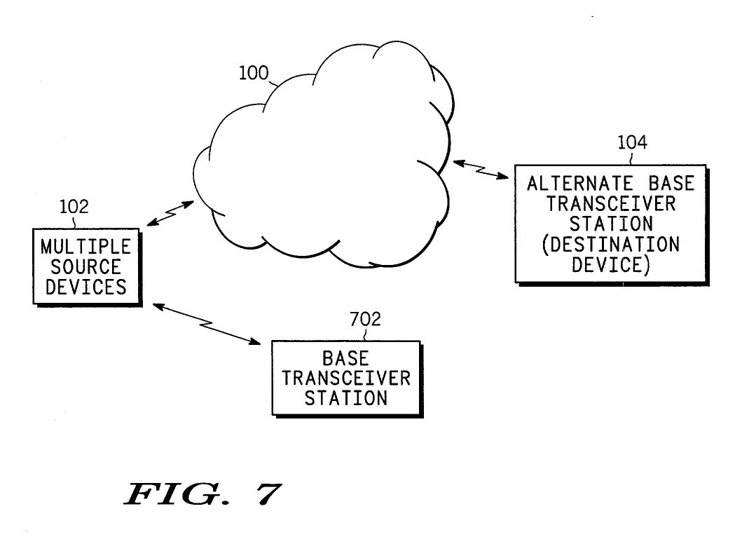

The self-positioning wireless transceiver system 100 can also be used to create a wide area network. For example, the self-positioning wireless transceiver system 100 can be deployed to relieve congestion within a wireless cellular communication system during events, such as football games, that are expected to attract large crowds to a particular area. More specifically, referring to FIG. 7, source devices 102 or cellular telephones that would ordinarily establish a communication link with a wireless cellular communication system via a particular BTS 702, may not be able to do so under conditions where the number of cellular telephones attempting to connect with the wireless cellular communication system within a particular cell creates a traffic overload condition with respect to that BTS 702. The self-positioning transceiver system 100 can be deployed in anticipation of such a situation to create a communication path between the cellular telephones or source devices 102 present within the congested cell and an alternate BTS or destination device 104 that would normally be outside of the communication range of those source devices 102 thereby diverting cellular telephone traffic from the congested cell to an alternate cell serviced by the alternate BTS 104.

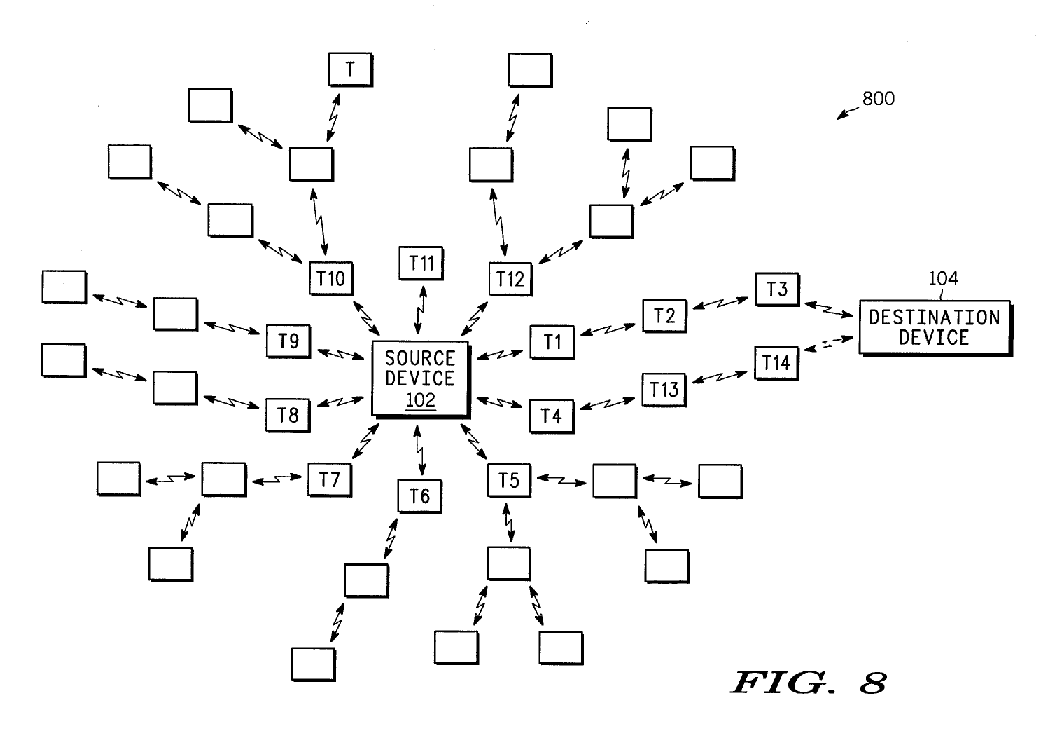

In yet another embodiment, shown in FIG. 8, a self-positioning wireless transceiver system 100 is deployed and instructed to maintain a scanning configuration 800 within communication range of the source device 102. When the need for the formation of a communication link between the source device 102 and a destination device 104 is detected, the self-positioning wireless transceiver system 100 automatically reconfigures itself to establish a communication link between the source device 102 and the desired destination device 104. Typically the scanning configuration 800 comprises a generally spherical configuration of self-positioning transceivers T surrounding the source device 102. The scanning configuration 800 typically increases the communication range of the source device 102 to a predefined communication range. When in a scanning configuration 800, a generally uniform distribution of a plurality of self-positioning transceivers T is created.

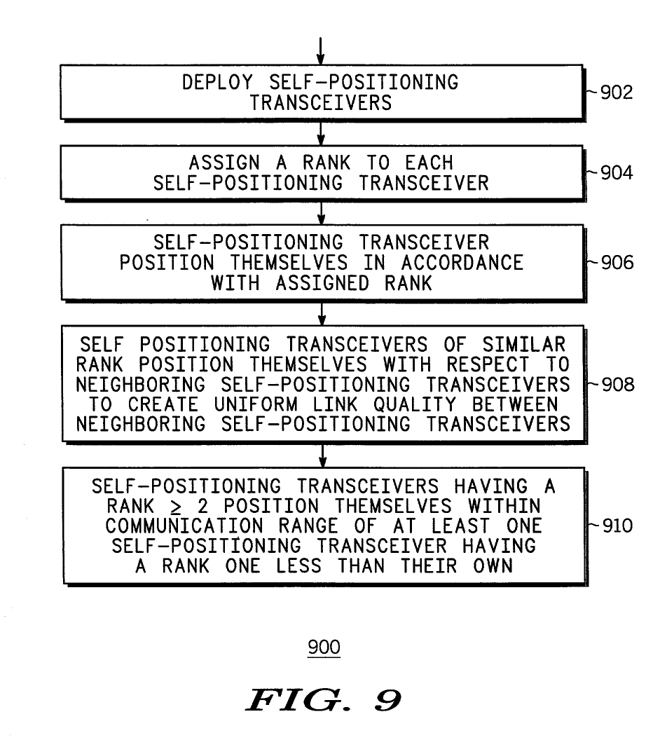

Referring to FIG. 9, a method of establishing a generally spherical scanning configuration 900 with respect to a source device 102 begins at step 902 with the deployment of a plurality of self-positioning transceivers T. At step 904, each of the self-positioning transceivers T is assigned a rank associated with the number of “hops” that the self-positioning transceiver T is assigned to position itself away from the source device 102. The self-positioning transceivers T are generally positioned at different tiers within the spherical scanning configuration 800 where each tier is associated with the number of “hops” a self-positioning transceiver T is removed from the source device 102. A “hop” is generally defined as a direct communication link between two neighboring self-positioning transceivers (T1, T2), (T2, T3) or a direct communication link between a self-positioning transceiver T3 and the destination device 104 or a direct communication link between the source device 102 and a self-positioning transceiver T1. For example, referring to FIG. 8, the self-positioning transceiver T1 is considered to be one “hop” away from the source device 102 while the self-positioning transceiver T2 is considered to be two “hops” away from the source device 102. The maximum number of “hops” within the spherical scanning configuration 800 generally defines the communication range of the self-positioning wireless transceiver system 100.

At step 906, the self-positioning transceivers T generally position themselves in accordance with the assigned rank. For example, self-positioning transceivers T having a rank of one, such as for example self-positioning transceiver T1, position themselves within communication range of the source device 102, self-positioning transceivers T having a rank of two, such as for example self-positioning transceiver T2, position themselves within communication range of at least one self-positioning transceiver T having a rank of one and so forth until all of the self-positioning transceivers T are in position.

Then at step 908, the self-positioning transceivers T1-T12 having a common rank position themselves uniformly with respect to each other such that there is uniform communication link quality between neighboring self-positioning transceivers T1-T12 having a particular rank, such as for example between the self-positioning transceiver pairs (T1, T4), (T4, T5). Each of the individual self-positioning transceivers T having a rank of two or greater position themselves to ensure that they are within communication range of one or more self-positioning transceivers T having a rank one less than their own rank at step 910. For example, each of the self-positioning transceivers having a rank of two (such as self-positioning transceiver T2) position themselves within communication range of one or more self-positioning transceivers having a rank of one (such as self-positioning transceiver T1).

In one embodiment, if the self-positioning wireless transceiver system 100 suffers the loss of a self-positioning transceiver T within an established primary communication link between a source device 102 and a destination device 104 consisting of a set of self-positioning transceivers T1, T2, T3, an alternate communication path can be created via an alternate set of self-positioning transceivers T4, T13, T14 to reestablish the communication link. In an alternate embodiment, once the need to establish a communication link between the source device 102 and a destination device 104 is detected, redundant communication paths are automatically created within the scanning configuration in the event the established or primary communication link between the source device 102 and the destination device 104 is disrupted. Furthermore, a greater number of self-positioning transceivers T may be deployed than necessary to create the scanning configuration 800 such that in the event a self-positioning transceiver T is lost or experiences a malfunction, one or more of the extra self-positioning transceivers T can step in to replace the problem self-positioning transceiver T.

In addition, while a generally spherical configuration 800 has been described, it should be noted that alternative forms of scanning configurations are also considered to be within the scope of the invention. In addition, alternative methods of creating spherical or other scanning configurations are also considered to be within the spirit of the invention.

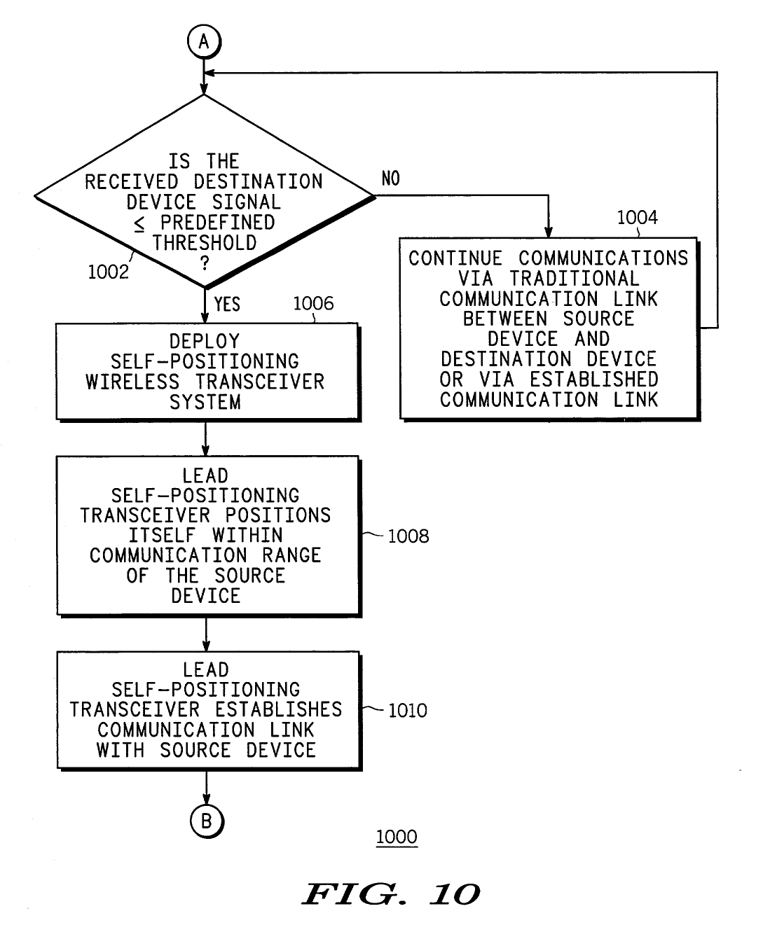

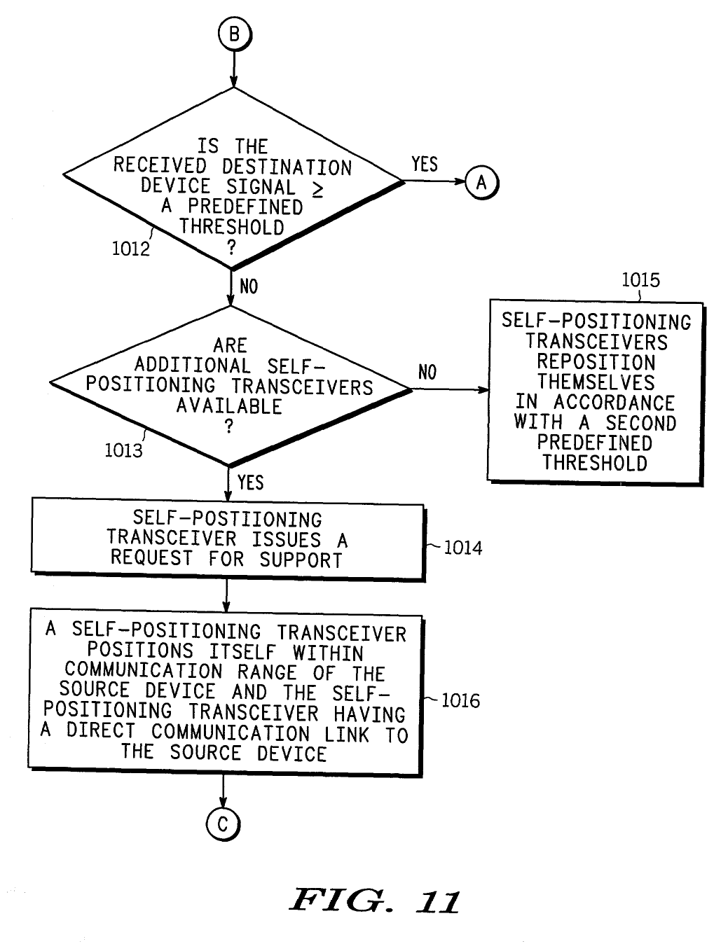

Referring to FIG. 10, a method 1000 of creating a communication link between a source device 102 and a destination device 104 via the self-positioning wireless transceiver system 100 is shown. Examples of positions of the self-positioning transceivers at various stages of the method 1000 are illustrated in FIG. 11. The described method 1000 may be used to maintain a weakening communication link between a source device 102, such as cellular telephone, and a wireless cellular communication system via a destination device 104, such as a BTS, as the cellular telephone is moving out of range of the wireless cellular communication system (shown in FIG. 11a).

The method 1000 begins at step 1002 with an assessment of whether the strength of the signal received by the source device 102 from the destination device 104 is less than a predefined threshold. If the received signal strength is determined to be greater than a predetermined threshold, the source device 102 continues communications with the destination device 104 via the traditional communication link at step 1004 and returns to step 1002 thereby conducting a periodic assessment of received signal strength from the destination device 104. If the received signal strength from the destination device 104 is determined to be less than the predefined threshold, the self-positioning wireless transceiver system 100 is deployed at step 1006.

Once the self-positioning wireless transceiver system 100 has been deployed, the lead self-positioning transceiver T1 positions itself within communication range of the source device 102 at step 1008 and establishes a communication link with the source device 102 at step 1010 (shown in FIG. 11b). At step 1012, the lead self-positioning transceiver T1 determines whether it is within range to receive signals that are greater than a primary pre-defined threshold from the destination device 104. Given the limited lower power transmission capabilities of the self-positioning transceivers T1, the primary pre-defined threshold is generally determined to identify when the lead self-positioning transceiver T1 in within communication range to transmit signals received from the source device 102 to the destination device 104. It should be noted that alternative methods of detecting when the lead self-positioning transceiver T1 is within communication range to both receive destination device signals and transmit signals that are capable of being received by the destination device 104 are also considered to be within the scope of the invention.

If the lead self-positioning transceiver T1 determines that it is within communication range of the destination device 104 to both receive signals from and transmit signals to the destination device 104, a sufficiently strengthened communication link is established and the method 1000 return to step 1002 to conduct periodic assessments of received signal strength from the destination device 104. If the lead self-positioning transceiver T1 determines that it is not within communication range of the destination device 104 to both receive signals from and transmit signals to the destination device 104, at step 1013, the wireless self-positioning transceiver system 10 determines whether additional self-positioning transceivers T are available to further extend the communication link. At step 1015, if additional self-positioning transceivers T are not available, the self-positioning transceivers T within the established communication link reposition themselves with respect to neighboring self-positioning transceivers T in accordance with a backup pre-defined threshold that is lower than the pre-defined primary threshold. The use of the lower pre-defined backup threshold permits the establishment of a somewhat weaker communication link between the source device 102 and the destination device 104 by “stretching” the communicatively coupled self-positioning transceivers T to the limit of their individual communication ranges. The self-positioning transceivers T also reposition themselves in an attempt to ensure that a somewhat uniform quality of signals are exchanged between neighboring self-positioning transceivers T. Of course, if the destination device 104 is beyond the “stretched” communication limits of the wireless self-positioning transceiver system 10, the communication link between the source device 102 and the destination device 104 will be terminated. In an alternative embodiment, the pre-defined primary threshold may be dynamically defined by the wireless self-positioning transceiver system 10 based on the number of self-positioning transceivers T within the communication link.

If additional self-positioning transceivers T are available, the lead self-positioning transceiver issues a request for additional self-positioning transceiver support at step 1014. At step 1016, a self-positioning transceiver T2 responds to the issued request by positioning itself within communication range of the source device 102 and within communication range of the self-positioning transceiver T1 having a direct communication link to source device 102. The newly positioned self-positioning transceiver T2 then establishes a communication link with the source device 102 and with the self-positioning transceiver T1 having a direct communication link with the source device 102 at step 1018 (shown in FIG. 11c).

At step 1020, the lead self-positioning transceiver T1 repositions itself a predefined incremental distance away from the source device 102 and towards the destination device 104 in a specific direction based on directional information derived from sensed destination device 104 signals. Then at step 1022, each of the individual self-positioning transceivers T2 involved in creation of the communication link between the source device 102 and the lead self-positioning transceiver T1, thus far, reposition themselves with respect to neighboring self-positioning transceivers T1 to optimize aggregate communication link quality between the source device 102 and the lead self-positioning transceiver T1 (shown in FIG. 11d).

Step 1012 is then repeated to determine whether the lead-positioning transceiver T1 is within communication range to both receive signals from and transmit signals to the destination device 104. If the lead self-positioning transceiver T1 is within communication range of the destination device 104, a strengthened communication link is established between the source device 102 and the destination device 104 and the method returns to the monitoring step 1002. Otherwise, steps 1014 through 1022 are repeated and additional self-positioning transceivers T3, T4 added until a sufficiently strengthened communication link is established between the source device 102 and the destination device 104 (shown in FIG. 11e).

Each of the self-positioning transceivers T within an established communication link between a source device 102 and a destination device 104 continuously monitors the quality of its communication links to neighboring self-positioning transceivers T and repositions itself as necessary, to optimize the quality of signal communicated from the source device 102 to the destination device 104. If the source device 102 moves in a direction away from the destination device 104, the length of the communication link is extended and may require the use of additional self-positioning transceivers T to maintain a quality communication link between the source device 102 and the destination device 104.

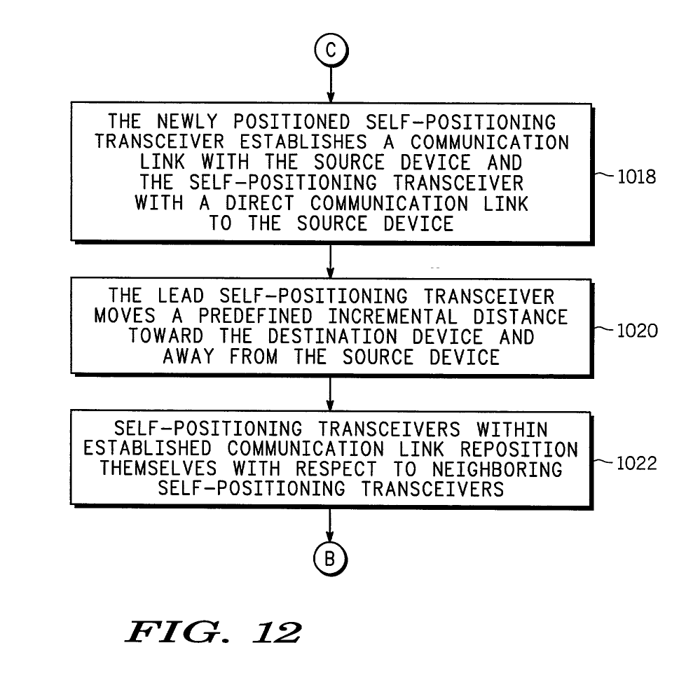

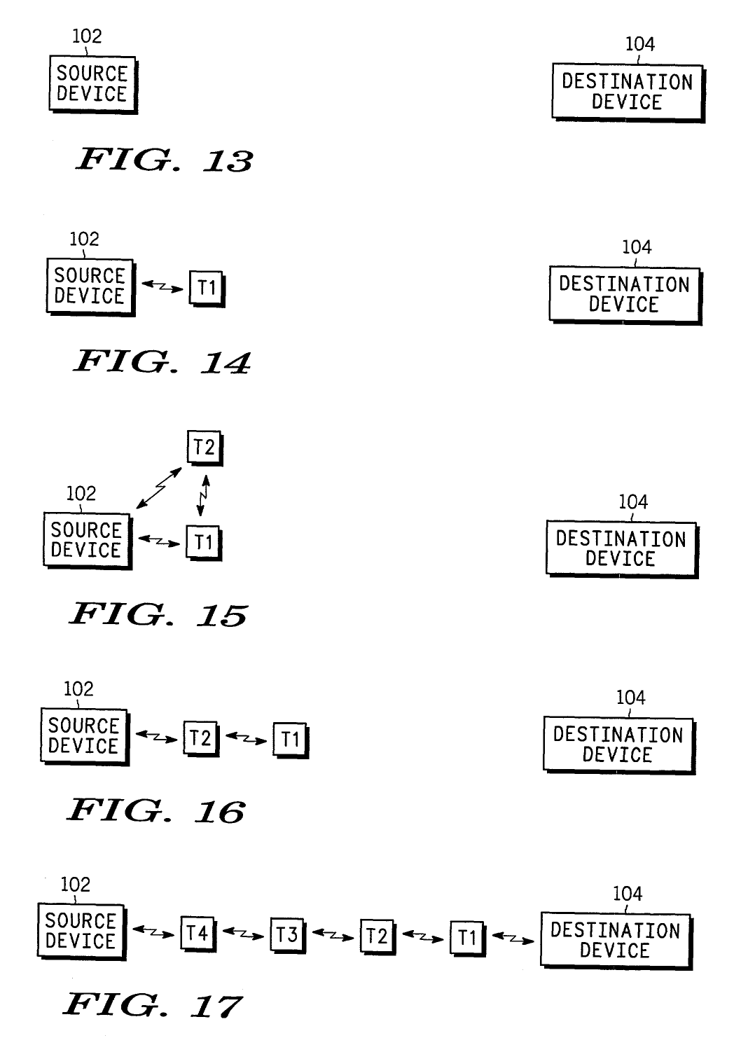

Referring to FIG. 12, a method 1200 of maintaining a quality communication link between the source device 102 and the destination device 104 as the source device 102 moves away relative to the destination device 104, is shown. FIG. 13 illustrates the relative positions of the self-positioning transceivers T1-T4, the source device 102 and the destination device 104 at different steps of the method 1200. The method 1200 begins at step 1202 with the self-positioning transceiver T3 having a direct communication link to the source device 102 determining whether a received signal from the source device 102 is below a predefined threshold. If the received signal from the source device 102 is greater than the predefined threshold, the self-positioning transceiver T3 maintains its position at step 1204 (shown in FIG. 13a). If the received signal is determined to be less than the predefined threshold, at step 1206, the self-positioning transceiver T3, directly communicatively linked to the source device 102, moves with the source device 102 to remain within communication range of the source device 102 (shown in FIG. 13b). At step 1208, the self-positioning transceivers T1, T2 communicatively linking the destination device 104 to the self-positioning transceiver T3, with a direct communication link to the source device 102, reposition themselves with respect to neighboring self-positioning transceivers T1, T2 in an attempt to optimize the quality of the aggregate communication link between the source device 102 and the destination device 104 (shown in FIG. 13c).

The quality of the signals exchanged via individual communication links by neighboring self-positioning transceivers T1-T3 are checked to determine if the quality of signals exchanged between neighboring self-positioning transceivers fall below a predefined primary threshold at step 1210. If the quality of the exchanged signals does not fall below the primary predefined threshold, the self-positioning transceivers T1-T3 maintain their new positions at step 1212. If the quality of the exchanged signals falls below the primary predefined threshold, at step 1213, the wireless self-positioning transceiver system 10 determines whether additional self-positioning transceivers T are available to further extend the communication link. At step 1215, if additional self-positioning transceivers T are not available, the self-positioning transceivers T within the established communication link reposition themselves with respect to neighboring self-positioning transceivers T in accordance with a pre-defined backup threshold that is lower than the predefined primary threshold. The use of the lower pre-defined backup threshold permits the establishment of a somewhat weaker communication link between the source device 102 and the destination device 104 by “stretching” the communicatively coupled self-positioning transceivers T to the limit of their individual communication ranges. The self-positioning transceivers T also reposition themselves in an attempt to ensure that a somewhat uniform quality of signals are exchanged between neighboring self-positioning transceivers T. Of course, if the destination device 104 is beyond the “stretched” communication limits of the wireless self-positioning transceiver system 10, the communication link between the source device 102 and the destination device 104 will be terminated. In an alternative embodiment, the pre-defined primary threshold may not be a fixed threshold but be dynamically defined by the wireless self-positioning transceiver system 10 based on the number of self-positioning transceivers T within the communication link.

If additional self-positioning transceivers T are available, a request is issued for additional self-positioning transceiver support at step 1214. Responsive to the issued request, a self-positioning transceiver T4 repositions itself and establishes communication links with at least one of the self-positioning transceivers T4 within the established communication link at step 1216 (shown in FIG. 13d). The self-positioning transceivers T1-T4 within the extended communication link reposition themselves with respect to each other to optimize the aggregate quality of the signals exchanged between the source device 102 and the destination device 104 at step 1208 (shown in FIG. 13e). Steps 1208 through 1216 are repeated until a communication link of sufficient quality is established between the source device 102 and the destination device 104.

On the other hand, if for example, the source device 102 moves in a direction towards the destination device 104, the length of the communication link may need to be contracted to eliminate the use of unnecessary self-positioning transceivers T within the communication link. Referring to FIG. 14, a method 1400 of accommodating the movement of a source device 102 towards a destination device 104 is shown. FIG. 15 illustrates the relative positions of the self-positioning transceivers T1-T4, the source device 102 and the destination device 104 at different steps of the method 1400.

At step 1402, the self-positioning transceiver T4 closest to the source device 102 determines whether the source device 102 has moved relatively closer to the destination device 104 based whether the quality of the source device signal received by the self-positioning transceiver T4 is greater than a predefined threshold. If the quality of the received source signal is below the predefined quality threshold, the self-positioning transceivers maintain their individual positions at step 1404 (shown in FIG. 15a). If the self-positioning transceiver T4 detects a movement of the source device 102 towards the destination device 104, at step 1406, all of the self-positioning transceivers T1-T4 within the established communication link reposition themselves with respect to neighboring self-positioning transceivers T1-T4 in an attempt to ensure that a somewhat uniform quality of signals are exchanged between neighboring self-positioning transceivers T1-T4 (shown in FIG. 15b). The self-positioning transceiver repositioning process generally seeks to optimize the aggregate quality of the signals transmitted between the source device 102 and the destination device 104.

The quality of the signals exchanged via individual communication links by neighboring self-positioning transceivers T1-T4 are checked to determine if the quality of signals exchanged between neighboring self-positioning transceivers exceeds a predefined threshold at step 1408. If the quality of the exchanged signals falls below the predefined threshold, the repositioned self-positioning transceivers T1-T4 maintain their positions at step 1410. If however, the quality of the exchanged signals exceeds the predefined threshold, at step 1411, the self-positioning transceiver T4 that is directly communicatively coupled to the source device 102 is identified and the self-positioning transceiver T3 directly communicatively coupled to the previously identified self-positioning transceiver T4 is also identified. A command is issued to the identified self-positioning transceiver T3 to establish communicatively coupling with the source device 102. If necessary, the self-positioning transceiver T3 repositions itself closer to the source device 102 to establish such coupling. A command is issued to the self-positioning transceiver T4 having a direct communication link to the source device 102 to withdraw from the communication link at step 1412. At step 1414, the self-positioning transceiver T4, having a direct communication link to the source device 102, withdraws from the communication link and (shown in FIG. 15c), and at step 1416, the remaining self-positioning transceivers T1-T3 reposition themselves with respect to each other such that each of the self positioning transceivers T1-T3 receives and transmits signals of somewhat uniform quality (shown in FIG. 15d).

In one embodiment of the wireless self-positioning transceiver system 10, each individual self-positioning transceiver T within an established communication link of a plurality of communicatively coupled self-positioning transceivers T is continuously monitoring the quality of its own communication links to neighboring self-positioning transceivers T. The wireless self-positioning transceiver system 10 maintains an aggregate communication link quality based on for example, the average quality of the communication links between neighboring self-positioning transceivers T. If for example, an individual communication link between neighboring self-positioning transceivers T falls below the aggregate communication link quality by a pre-defined threshold, the two neighboring self-positioning transceivers T move closer together in an attempt to improve their communication link. If on the other hand, for example, an individual communication link between neighboring self-positioning transceivers T appears to be above the aggregate communication link quality by a pre-defined threshold, the two self-positioning transceivers T move further apart in an attempt to create uniform link quality between neighboring self-positioning transceivers T. Data pertaining to the monitoring of individual communication links and continuous repositioning is shared by the plurality of self-positioning transceivers T within the established communication link. The continuous monitoring of aggregate communication link quality via the monitoring and repositioning of individual communication links between neighboring self-positioning transceivers T minimizes short term aberrations of communication link quality.

In one embodiment of the invention, the self-positioning wireless transceiver system 100 can detect when the path of the movement of the source device 102 with respect to the destination device 104 causes the communicatively linked self-positioning transceivers T1-T10 to create a crossover configuration, an example of which is shown in FIG. 16a. Continuous communications between the self-positioning transceivers T1-T10 permits both the detection and the elimination of the crossover configuration. For example, the self-positioning transceivers T2, T3 do not normally expect to be within direct communication range of self-positioning transceivers T8, T9 when the self-positioning transceivers T2, T3, T8, T9 are all within the same communication link, thereby indicating to the self-positioning wireless transceiver system 100 that a crossover configuration has been created. In response to the detection of the crossover configuration, the self-positioning wireless transceiver system 100 reconfigures itself, as shown in FIG. 16b, to create a shorter and relatively more efficient communication link comprising a reduced number of self-positioning transceivers T1, T2, T9, T10. The remaining self-positioning transceivers T3-T8 simply remove themselves from the communication link.

At the conclusion of desired communications between the source device 102 and one or more destination devices 104 or the source device 102 or the destination device 104 move out of the communication range that can be supported by the self-positioning wireless transceiver system 100, the self-positioning transceivers T are typically retrieved. In one embodiment of the invention, the user simply retraces her path back to where the self-positioning transceivers T were initially deployed and manually collects the deployed self-positioning transceivers T. A master device emitting a “homing signal” via the control channel may be used to facilitate the collection of the deployed self-positioning transceivers T. In such a case each self-positioning transceiver T may be programmed to announce its presence by, for example, emitting an audio signal when it detects the presence of the master device within a predefined range. In one embodiment, the source device 102 may be configured to perform the functions of the master device. In an alternate embodiment, the master device may issue a homing signal via the control channel instructing the self-positioning transceivers T to return to the location of the master device or perhaps to a predefined “home” location. In another embodiment, individual self-positioning transceivers T may employ detected changes in the signal strength of a homing signal to “follow” the homing signal to a “home” location.

Referring to FIG. 17 a method 1700 of retrieving deployed self-positioning transceivers T is described. The method 1700 begins at step 1702 with a determination of whether the self-positioning transceivers T detected the need to form a communication link during a predefined period of downtime. If the predetermined period of downtime has not yet elapsed, the self-positioning transceivers T hold their respective positions. If the self-positioning transceivers T have not been required to form a communication link for the predefined period of downtime, the self-positioning transceivers T initiate a search to locate a“homing signal” transmitted via the control channel at step 1704. The self-positioning wireless transceiver system 100 then determines whether the “homing” signal has been detected at step 1706. If the “homing signal” is detected by at least one of the self-positioning transceivers T at step 1706, data parameters associated with location and direction of the “homing signal” is communicated to the other self-positioning transceivers T at step 1708. At step 1710 the self-positioning transceivers T follow the “homing signal” to the “home” location.

If the “homing signal” cannot be detected, at step 1712, the self-positioning transceivers T remain communicatively coupled while widening their search for the “homing signal” by repositioning themselves incremental distances away from a known location 1712. The self-positioning transceivers T retain a record of data parameters associated with the incremental distance movements so that, if necessary, the self-positioning transceivers T can retrace their path back to the known location. If at least one of the self-positioning transceivers T detect the “homing signal”, at step 1708 the self-positioning transceivers T communicate the “homing signal” data with each other and follow the homing signal to the “home” location at step 1710.

If the self-positioning transceivers are unable to detect the “homing signal” within a predefined period of time at step 1714, the “lost” self-positioning transceivers issue a help request, recognizable by the master device, on the control channel at step 1716. If the master device happens to be within communication range of the “lost” self-positioning transceivers T, the master device issues a command instructing the self-positioning transceivers T to remain at the known location pending manual retrieval. In an alternate embodiment, the master device may communicate instructions to the “lost” self-positioning transceivers T to guide them back “home”.

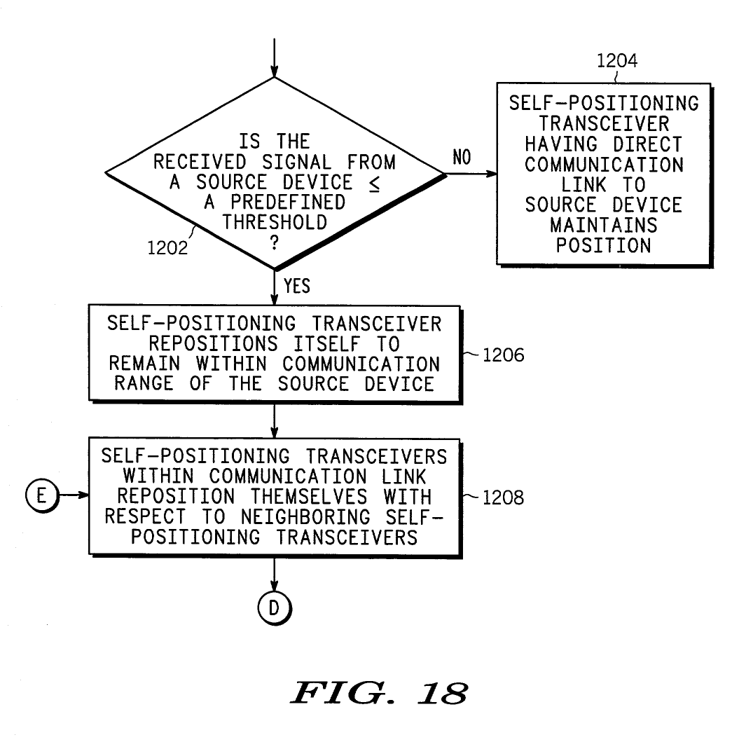

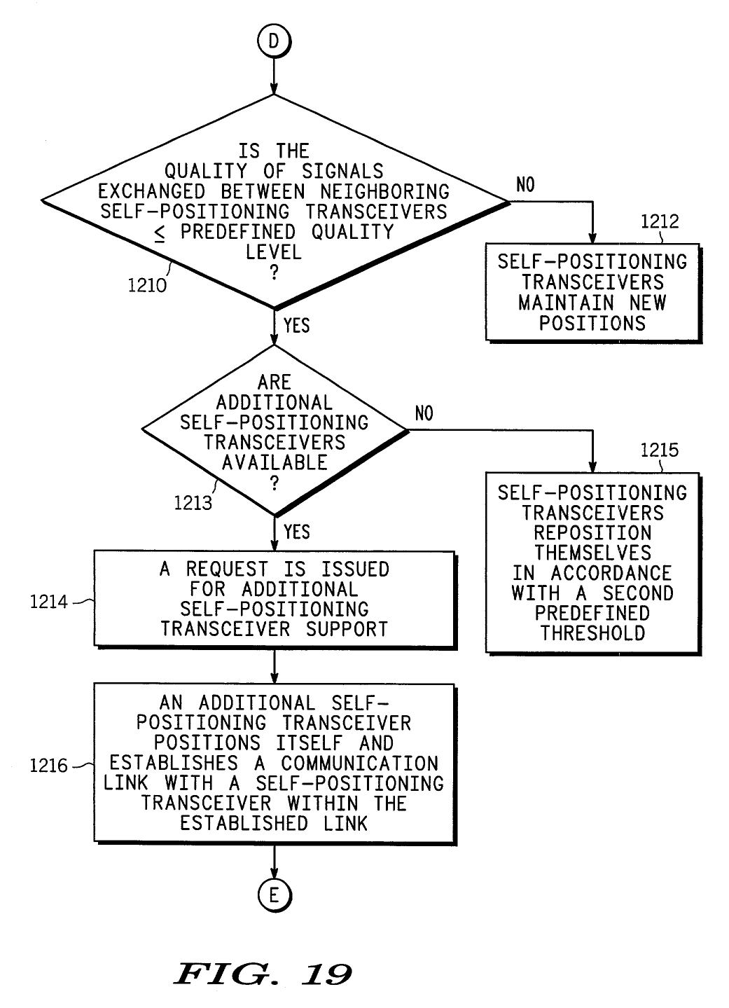

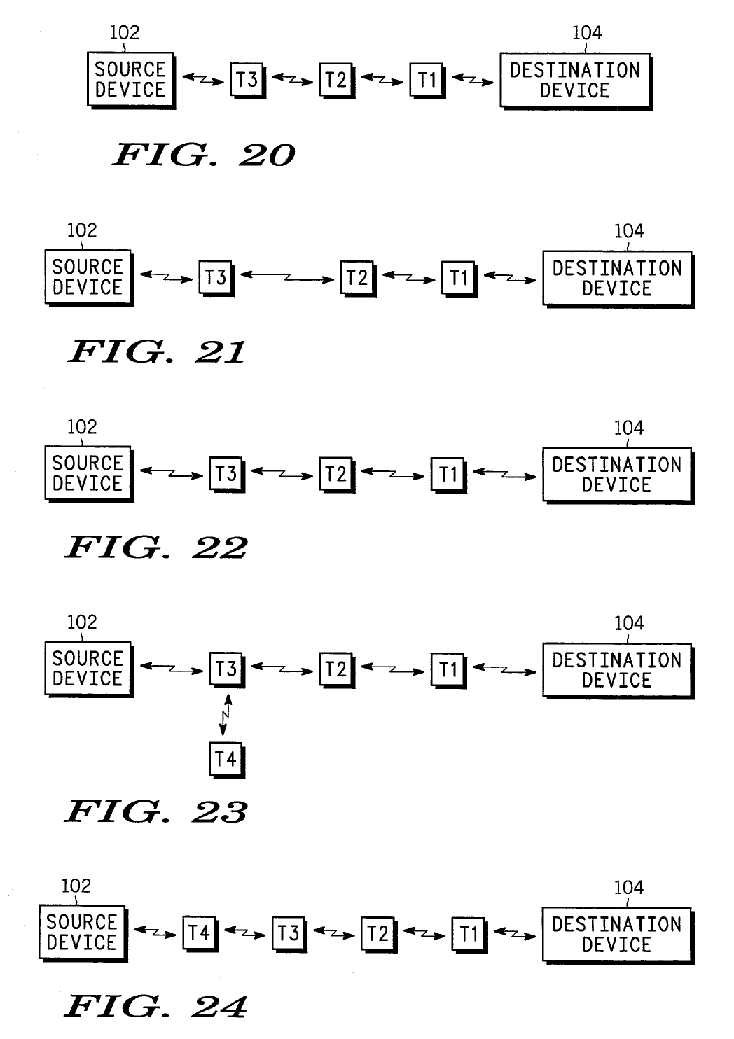

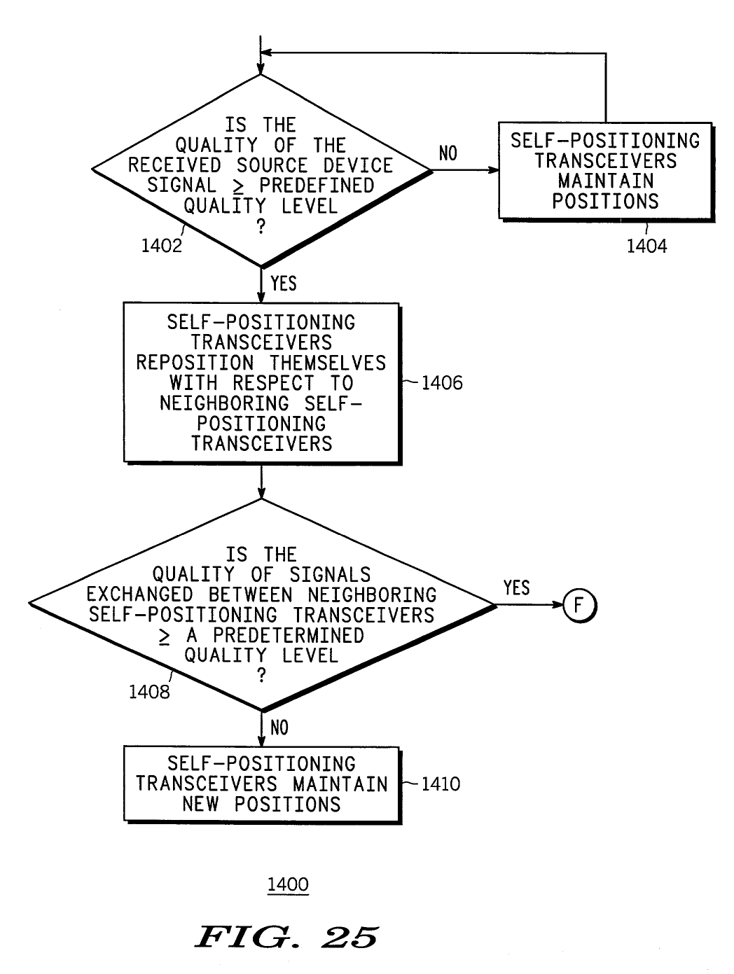

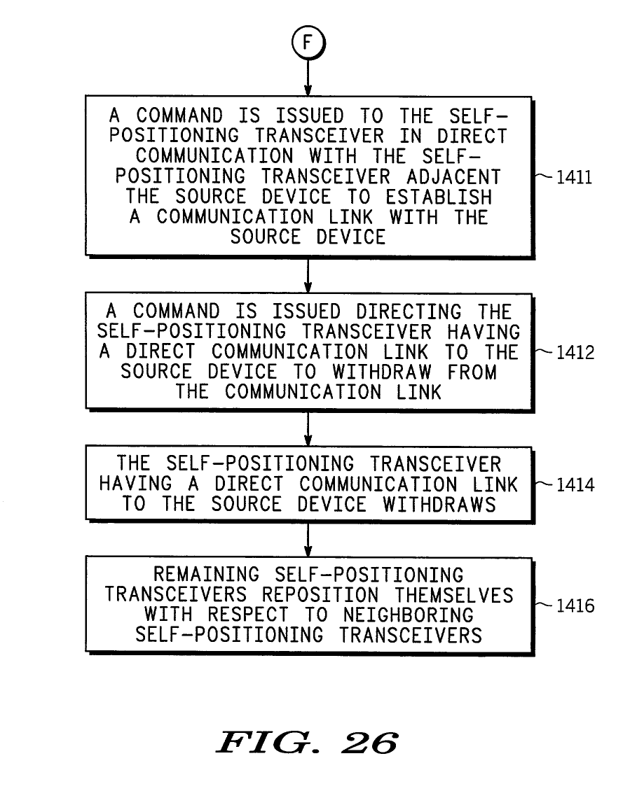

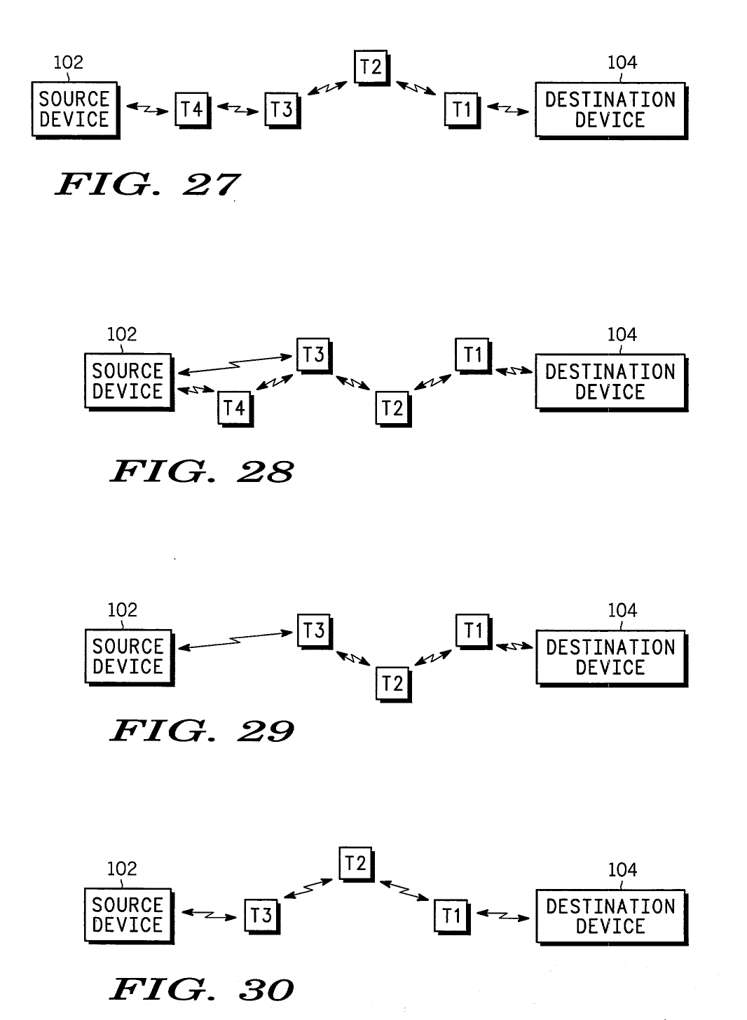

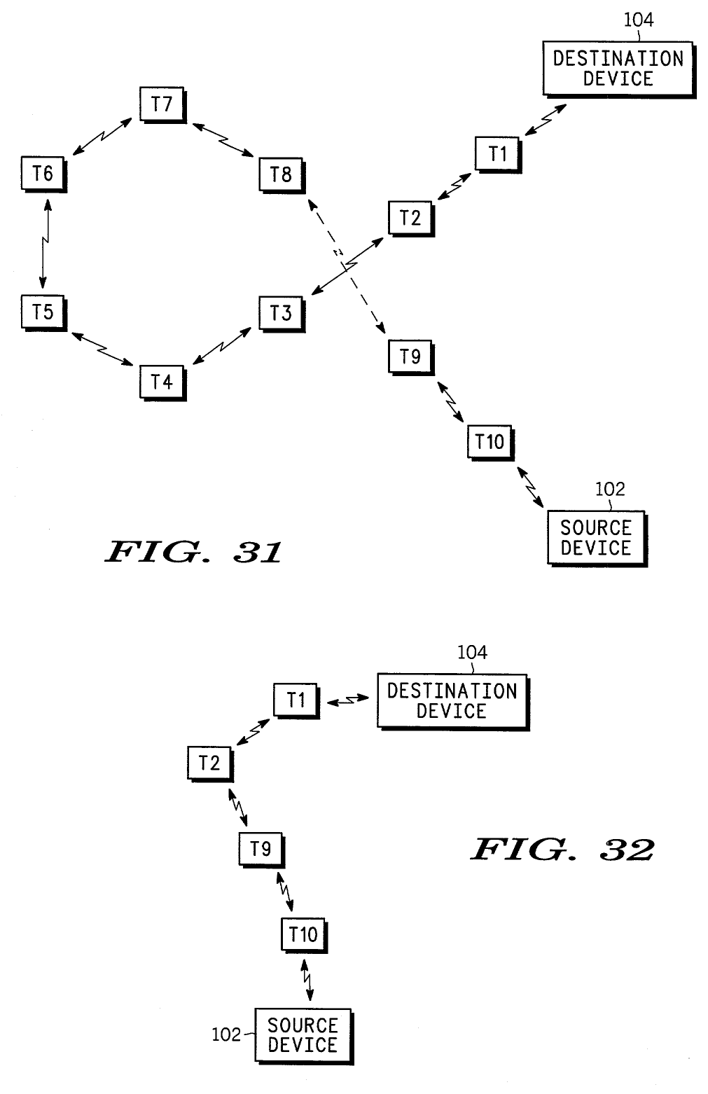

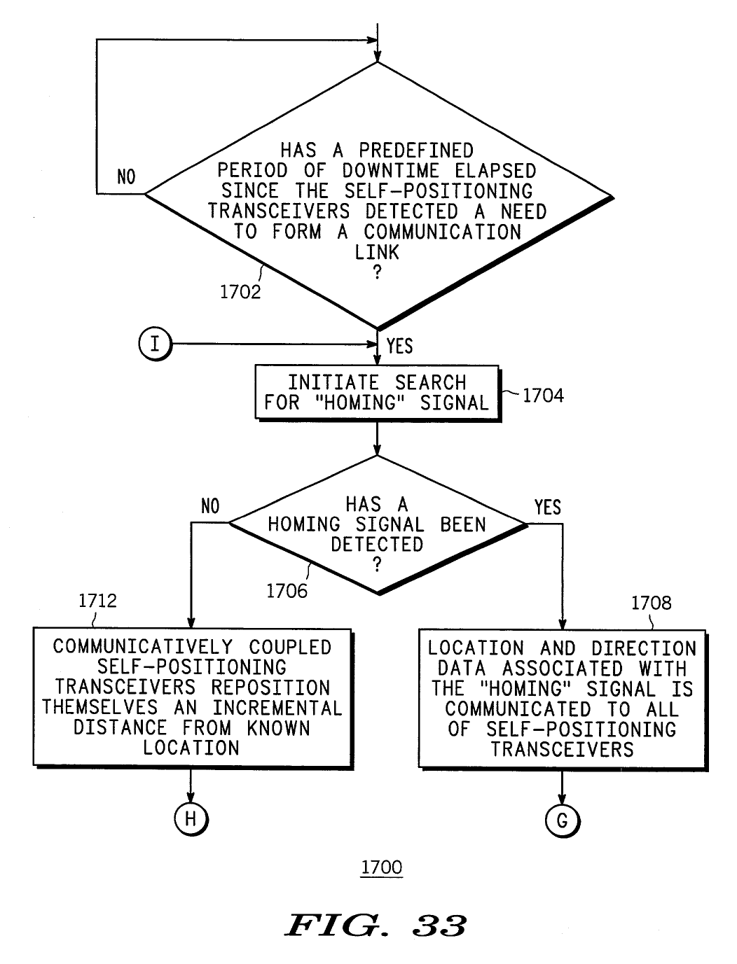

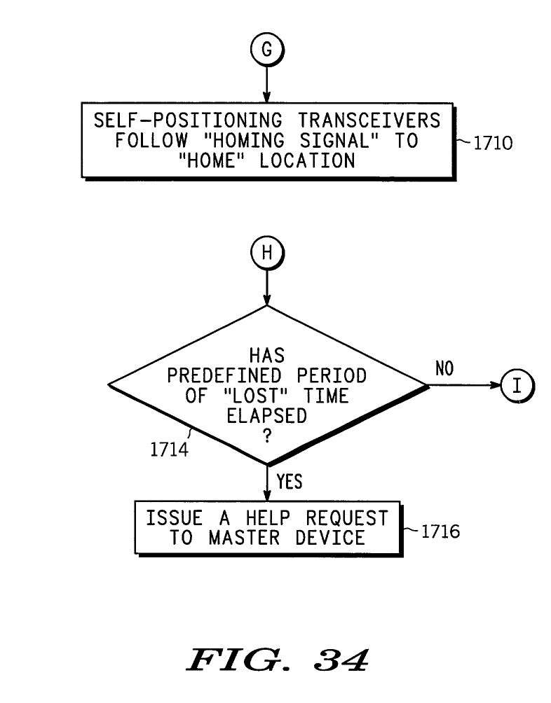

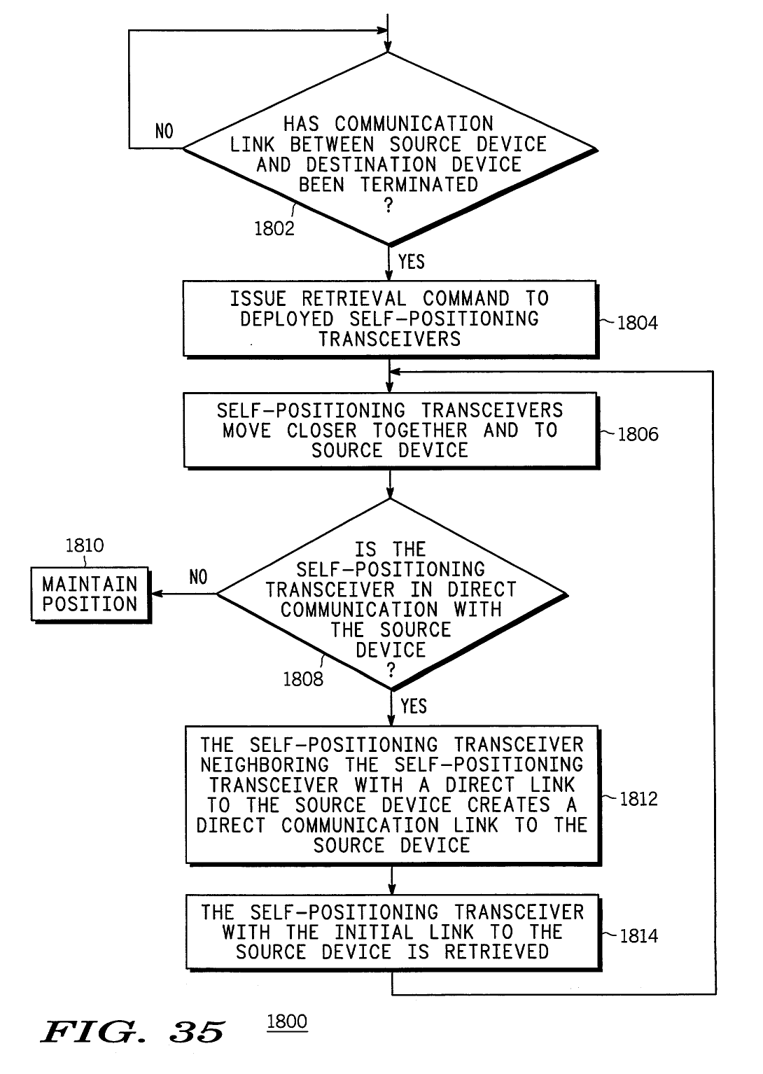

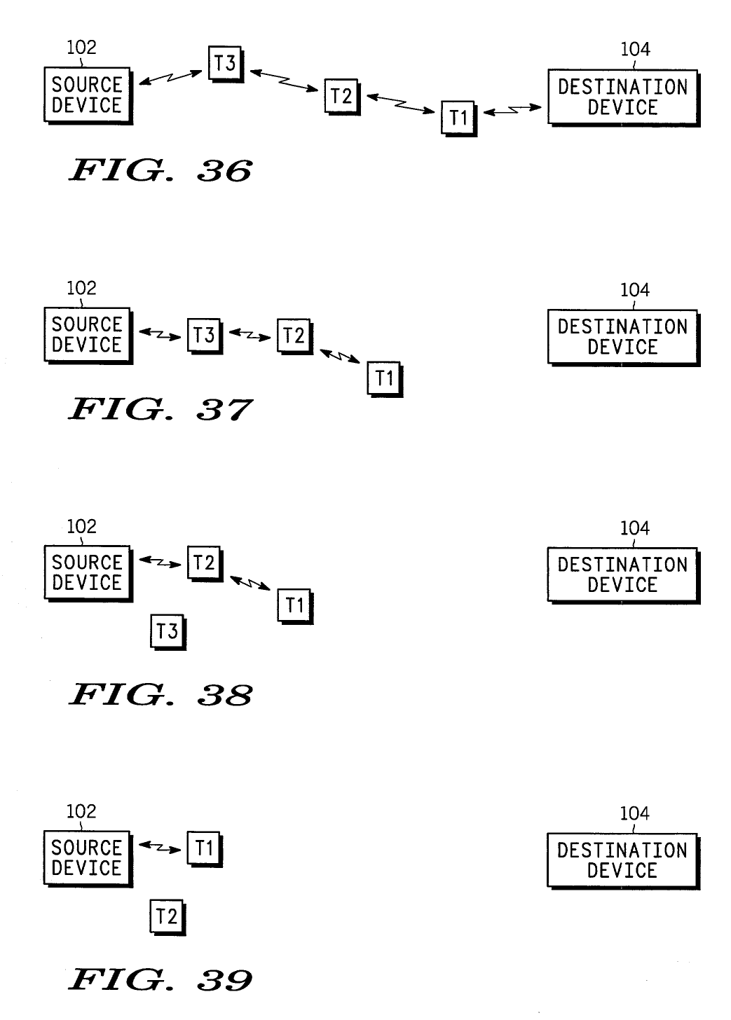

In an alternative embodiment, when a communication link between a source device 102 and a destination device 104 is terminated, the plurality of communicatively linked self-positioning transceivers T1-T3 can be retrieved by “pulling” the communicatively linked self-positioning transceivers T1-T3 back to the location of the source device 102. Referring to FIG. 18, the method 1800 of retrieving deployed self-positioning transceivers T1-T3 by “pulling” them in is shown. FIG. 19 illustrates the relative positions of the self-positioning transceivers T1-T3, the source device 102 and the destination device 104 at various stage of the method 1800.

The method 1800 begins at step 1802 with a determination of whether a previously established communication link between the source device 102 and the destination device 104 has been terminated. (The positions of the self-positioning transceivers T1-T3 creating the communication link between the source device 102 and the destination device 104 are shown in FIG. 19(a)) If the communication link is detected as terminated, a retrieval command is issued to the self-positioning transceivers T1-T3 at step 1804. Upon receiving the retrieval command, at step 1806, the self-positioning transceivers T1-T3 move closer together with respect to neighboring self-positioning transceivers T1-T3 (shown in FIG. 19(b)) and the source device 102 such that the self-positioning transceiver T2 adjacent the self-positioning transceiver T3 in direct communication with the source device 102 can easily establish a direct communication link with the source device 102. At step 1808, each self-positioning transceiver T1-T3 determines if it is in communication with the source device 102 via a direct communication link. The self-positioning transceiver T2, T3 not in direct communication with the source device 102 maintain their positions at step 1810. At step 1812, the self-positioning transceiver T2 adjacent the self-positioning transceiver T3 in direct communication with the source device 102 establishes a direct communication link with the source device 102 and at step 1814, the self-positioning transceiver T3 that was initially in direct communication with the source device 102 terminates communicative coupling with the source device 102 and is retrieved (shown in FIG. 19(c)). The method 1800 then returns to step 1806 where the remaining self-positioning transceivers T1, T2 move closer together and the self-positioning transceivers T1, T2 operate to identify the self-positioning transceiver with a direct link to the source device at step 1808. Steps 1810-1814 are repeated again to retrieve the next self-positioning transceiver T2 (shown in FIG. 19(d)). Steps 1806-1814 are repeated until all of the self-positioning transceivers T are retrieved.

In an alternative embodiment, the retrieval command 1804 can be issued if the self-positioning transceiver T determine that a predefined period of time has elapsed without detecting the need to create a communication link.

Still other modifications and alternative embodiments of the invention will be apparent to those skilled in the art in view of the foregoing description. The description is to be construed as illustrative only, and is for the purpose of teaching those skilled in the art the best mode of carrying out the invention. The details of the structure and method may be varied substantially without departing from the spirit of the invention, and the exclusive use of all modifications which come within the scope of the appended claims is reserved.

We claim:

1. A method of establishing a wireless communication path between a first device and a second device, the method comprising the steps of:
automatically positioning a self-positioning wireless transceiver system within communication range of a first device and a second device;
establishing communicative coupling between the self-positioning wireless transceiver system and the first device; and
establishing communicative coupling between the self-positioning wireless transceiver system and the second device while maintaining communicative coupling with the first device.

2. The method of claim 1, wherein the self-positioning wireless transceiver system comprises a first self-positioning transceiver.

3. The method of claim 1, wherein the self-positioning wireless transceiver system comprises first and second self-positioning transceivers.

4. The method of claim 3, further including a step of transmitting data from the first self-positioning transceiver to the second self-positioning transceiver via at least one of radio frequency, infrared frequency and ultrasonic frequency communication channels.

5. The method of claim 4, wherein the step of transmitting data further includes transmitting self-positioning transceiver operational data via a control channel and transmitting communication data via a payload channel.

6. The method of claim 4, wherein the step of transmitting data further includes transmitting at least one of voice data, text date, image data, video data and audio data.

7. The method of claim 1, wherein the self-positioning transceiver system operates in accordance with one of Bluetooth, IEEE 802.11, IEEE 802.11a, IEEE 802.11b and IEEE 802.11g industry specifications.

8. The method of claim 2, wherein the first self-positioning transceiver further comprises a mobility mechanism.

9. The method of claim 8, wherein the mobility mechanism comprises one of a flying mobility mechanism, a hovering mobility mechanism, a swimming mobility mechanism, and a crawling mobility mechanism.

10. The method of claim 8, wherein the mobility mechanism comprises one of a land-craft, aircraft and watercraft that is responsive to a wireless communication signal.

11. The method of claim 1, wherein the self-positioning wireless transceiver system comprises a plurality of self-positioning transceivers, the method further including a step of deploying the plurality of self-positioning transceivers in a pre-defined configuration.

12. The method of claim 1, wherein the self-positioning wireless transceiver system comprises a plurality of self-positioning transceivers, the method further including a step of deploying the plurality of self-positioning transceivers in a pre-defined swarm configuration.

13. The method of claim 1, wherein the self-positioning wireless transceiver system comprises a plurality of self-positioning transceivers, the method further including a step of deploying the plurality of self-positioning transceivers to search for a signal transmitted by the second device in pre-defined searching pattern.

14. The method of claim 1, wherein the self-positioning wireless transceiver system comprises first and second pluralities of self-positioning transceivers, the method further including the steps of employing the first plurality of self-positioning transceivers to communicatively couple the first device to the second device and employing the second plurality of self-positioning transceivers to create a second communication path adapted to communicatively couple the first device to the second device.

15. The method of claim 1, wherein the self-positioning wireless transceiver system comprises first, second and third self-positioning transceivers, the method further including the step of the second self-positioning transceiver automatically positioning itself with respect to the first and third self-positioning transceivers such that the quality of a first communication signal received from the first self-positioning transceivers and the quality of a second communication signal received from the third self-positioning transceiver are approximately equal.

16. The method of claim 1, wherein the self-positioning wireless transceiver system comprises first and second self-positioning transceivers, the method further including the steps of:
positioning the first self-positioning transceiver positioning within communication range of the first device;
establishing communicative coupling between the first transceiver and the first device;
if the signal received from the second device is less than a first threshold, issuing a request to a second self-positioning transceiver for support;
positioning the second self-positioning transceiver within communication range of the first self-positioning transceiver and the first device;
establishing communicative coupling between the second self-positioning transceiver and the first device;
establishing communicative coupling between the second self-positioning transceiver and the first self-positioning transceiver;
positioning the first self-positioning transceiver a predefined incremental distance toward the second device; and
positioning the second self-positioning transceiver with respect to the first self-positioning transceiver and with respect to the first device such that the quality of a first communication signal received from the first self-positioning transceivers and the quality of a second communication signal received from the first device are approximately equal.

17. The method of claim 16, wherein the first threshold is one of a primary pre-defined threshold, a pre-defined backup threshold and a dynamically determined threshold.

18. The method of claim 1, wherein the self-positioning wireless transceiver system comprises a plurality of self-positioning transceivers wherein a subset of the plurality of self-positioning transceivers are communicatively coupled to create a communication link from the first device to the second device, the method further including the steps of:
detecting a movement of the first device relative to the position of the second device;
positioning the first self-positioning transceiver of the subset of self-positioning transceivers repositioning to remain within communication range of the first device;
repositioning each of the subset of self-positioning transceivers communicatively coupling the first self-positioning transceiver to the second device with respect to a neighboring self-positioning transceiver such that the quality of each communication signal received by each of the subset of self-positioning transceivers from a neighboring self-positioning transceiver are approximately equal;
if the quality of a signal received by at least one of the subset of self-positioning transceivers from a neighboring self-positioning transceiver is less than a first threshold, issuing a request to a second self-positioning transceiver for support and
if the quality of a signal received by at least one of the subset of self-positioning transceivers from a neighboring self-positioning transceiver is greater than a second threshold, issuing a request to one of the subset of self-positioning transceivers to communicatively decouple itself from the first device, the second device and the other self-positioning transceivers of the subset of self-positioning transceivers.

19. The method of claim 18, wherein the first threshold is one of a primary pre-defined threshold, a backup pre-defined threshold and a dynamically determined threshold.

20. The method of claim 1, wherein the self-positioning wireless transceiver system comprises a plurality of self-positioning transceivers wherein the plurality of self-positioning transceivers are communicatively coupled to create a communication path between the first device and the second device, the method further including the steps of:
detecting that the configuration of the plurality of communicatively coupled self-positioning transceivers is in a crossover configuration;
identifying a relatively shorter communication path defined by a subset of the plurality of self-positioning transceivers; and
issuing a command to the plurality of self-positioning transceivers that are not a member of the subset to communicatively decouple themselves from the first device, the second device and the subset of the plurality of self-positioning transceivers.

21. The method of claim 1, wherein the self-positioning wireless transceiver system comprises a plurality of communicatively coupled self-positioning transceivers further including the steps of:
detecting a termination of communicative coupling between the first device and the second device; and
retrieving the plurality of self-positioning transceivers.

22. The method of claim 21, further including the steps of:
(i) determining that a predetermined period has passed without the detection of a need to form a communication link between the first device and the second device;
(ii) initiating a search for a homing signal generated from a home location;
(iii) searching for the homing signal;
(iv) if the homing signal is detected, following the homing signal to the home location;
(v) if the homing signal cannot be detected, at least one of the plurality of self-positioning transceivers positioning itself an incremental distance away from a reference position to search for the homing signal; and
(vi) repeat steps (iii) through (v) until the homing signal is detected.

23. The method of claim 22, further including the step of if a predetermined period of time has elapsed since the execution of step (ii), issuing a request for help in locating the homing signal.

24. The method of claim 21, further including the steps of:
(i) issuing a retrieve command to the plurality of self-positioning transceivers;
(ii) each of the plurality of self-positioning transceivers positioning itself closer to a neighboring self-positioning transceiver in the approximate direction of the first device;
(iii) identifying a self-positioning transceiver of the plurality that is directly communicatively coupled to the first device;
(iv) communicatively decoupling the identified self-positioning transceiver from the other of the plurality of self-positioning transceivers and from the first device;
(v) repeat steps (ii) through (iv) until the plurality of self-positioning transceivers have been communicatively decoupled from the first device.

25. A method of increasing the communication range of a first device, the method comprising the steps of:
providing a plurality of self-positioning transceivers, each of the plurality of self-positioning transceivers including a mobility mechanism adapted to enable each of the plurality of self-positioning transceivers to automatically position itself;
each of the plurality of self-positioning transceivers automatically positioning itself with respect to the first device; and
establishing communicative coupling between each of the plurality of self-positioning transceivers and the first device.

26. The method of claim 25, further including the steps of:
each of a first subset of the plurality of self-positioning transceivers automatically positioning itself within communication range of the first device;
establishing communicative coupling between the first subset of the plurality of self-positioning transceivers and the first device;
each of a second subset of the plurality of self-positioning transceivers automatically positioning itself within communication range of at least one of the first subset of the plurality of self-positioning transceivers; and
establishing communicative coupling between each of the second subset of the plurality of self-positioning transceivers and the first device via at least one of the first subset of the plurality of self-positioning transceivers.

27. The method of claim 26, wherein the step of the first subset of the plurality of self-positioning transceivers automatically positioning itself within communication range of one of the first device further includes the steps of:
a first self-positioning transceiver receiving a first communication signal directly from a first neighboring self-positioning transceiver;
the first self-positioning transceiver receiving a second communication signal directly from a second neighboring self-positioning transceiver;
the first self-positioning transceiver automatically positioning itself with respect to the first and second neighboring self-positioning transceivers such that the quality of the communication signals received from the first and second neighboring self-positioning transceivers are approximately equal.

28. The method of claim 25, wherein the step of providing a plurality of self-positioning transceivers further comprises providing a plurality of self-positioning transceivers including a mobility mechanism comprising one of a flying mechanism, a hovering mechanism, a swimming mechanism and a crawling mechanism.

29. The method of claim 25, wherein the step of providing a plurality of self-positioning transceivers further comprises providing a plurality of self-positioning transceivers including a mobility mechanism comprising a micromechanical flying insect robot.

30. The method of claim 25, wherein the plurality of self-positioning transceivers includes a first subset of self-positioning transceivers and the method further includes the step of communicatively coupling the first device to a second device via the first subset of communicatively coupled self-positioning transceivers.

31. The method of claim 30, wherein the plurality of self-positioning transceivers includes a second subset of self-positioning transceivers and the method further includes the step of creating a first alternate communication path between the first device and the second device via the second subset of communicatively coupled self-positioning transceivers.

32. The method of claim 31, wherein if at least one of the first subset of self-positioning transceivers experiences a malfunction, establishing communicative coupling between the first device and the second device via the first alternate communication path.

33. The method of claim 30, wherein the plurality of self-positioning transceivers includes a second subset of self-positioning transceivers and the method further includes the step of if the strength of a communication signal received by one of the first and second devices falls below a predefined threshold, the second subset of the communicatively coupled self-positioning transceivers automatically positioning themselves to maintain communicative coupling between the first device and the second device.

34. The method of claim 33, wherein the plurality of self-positioning transceivers includes a third subset of self-positioning transceivers and the method further includes the step of the third subset of the communicatively coupled self-positioning transceivers automatically positioning themselves to create a second alternate communication path between the first device and the second device.

35. A self-positioning transceiver adapted to provide communicatively coupling between a first device and a second device, the self-positioning transceiver system comprising:
a transmitter;
a receiver;
a mobility mechanism adapted to carry the transmitter and the receiver; and
a processor communicatively coupled to the transmitter, the receiver and the mobility mechanism, the processor being adapted to operate in accordance with a computer program embodied on a computer-readable medium, the computer program comprising:
a first routine that directs processing of communication data received from the first device via the receiver;
a second routine that directs transmission of the communication data received from the first device to the second device via the transmitter; and
a third routine that issues a position command to the mobility mechanism based on the quality of a signal received by the receiver from the first device and based on the quality of a signal received by the receiver from the second device.

36. The self-positioning transceiver of claim 35, wherein the combination of the transmitter and the receiver comprise a transceiver.

37. The self-positioning transceiver of claim 37, wherein the mobility mechanism comprises one of a flying mechanism, a hovering mechanism, a swimming mechanism and a crawling mechanism.

38. The self-positioning transceiver of claim 35, wherein the mobility mechanism comprises one of a land-craft, aircraft and watercraft that is responsive to a wireless communication signal.

39. The self-positioning transceiver of claim 35, wherein the transmitter is adapted to transmit communication data to one of a source device, a destination device and a neighboring self-positioning transceiver.

40. The method of claim 35, wherein the transmitter is adapted to transmit a signal in accordance with one of Bluetooth, IEEE 802.11, IEEE 802.11a, IEEE 802.11b and IEEE 802.11g industry specifications.

41. The self-positioning transceiver of claim 35, wherein the receiver is adapted to receive communication data from one of a source device, a destination device and a neighboring self-positioning transceiver.

42. The self-positioning transceiver of claim 35, further including a random access memory for maintaining self-positioning transceiver operational data.

43. The self-positioning transceiver of claim 35, further comprising a fourth routine that issues the position command to the mobility mechanism in accordance with a pre-defined search pattern.

44. The self-positioning transceiver of claim 35, wherein the transmitter transmits self-positioning transceiver operational data to a neighboring self-positioning transceiver via a control channel and communication packet data via a payload channel to one of a source device, a destination device and a neighboring self-positioning transceiver.

45. The self-positioning transceiver of claim 35, wherein the transmitter is adapted to transmit communication data via at least one of radio frequency, infrared frequency and ultrasonic frequency communication channels.

46. The self-positioning transceiver of claim 35, further including a fourth routine that directs a periodic monitoring of the communication link quality between the self-positioning transceiver and a neighboring self-positioning transceiver.

47. The self-positioning transceiver of claim 46, further including a fifth routine that maintains an aggregate communication link quality based on communication link quality data received from a plurality of self-positioning transceivers, the plurality of self-positioning transceivers being communicatively coupled to the self-positioning transceiver.

48. The self-positioning transceiver of claim 47, further including a sixth routine that issues a command to the mobility mechanism to reposition the self-positioning transceiver closer to the neighboring self-positioning transceiver if the communication link quality between the self-positioning transceiver and the neighboring self-positioning transceiver falls below the aggregate communication link quality by a pre-defined threshold.

49. The self-positioning transceiver of claim 47, further including a sixth routine that issues a command to the mobility mechanism to reposition the self-positioning transceiver further away from the neighboring self-positioning transceiver if the communication link quality between the self-positioning transceiver and the neighboring self-positioning transceiver exceeds the aggregate communication link quality by a pre-defined threshold.
